(19) United States
(12) Patent Application Publication
(10) Pub. No.: US 2008/0213079 A1
(43) Pub. Date: Sep. 4, 2008

(54) Apparatus and Method for Separating and Transporting Substrates

(76) Inventors: Richard Herter, Denzlingen (DE); Konrad Kaltenbach, Furtwangen (DE)

Correspondence Address: BIOTECH BEACH LAW GROUP , PC, 625 BROASWAY, Suite 1210, SAN DIEGO, CA, 92101, US

(21) Appl. No.: 12/064,451

(22) PCT Filed: Jul. 5, 2007
(86) PCT No.: PCT/EP2007/005968

§ 371 Date: Feb. 21, 2008

(30) Foreign Application Priority Data
Jul. 6, 2006 (DE) 10 2006 031 629.0
Dec. 15, 2006 (EP) 06026054.4

(51) Int. Cl. B65G 57/32; B28D 5/00

(52) U.S. Cl. 414/788.1; 414/802

(57) ABSTRACT

The invention relates in particular to the separation and transportation of a disc shaped substrate (102; 202) such as e.g. a solar wafer.

The invention is characterized by the fact that separations take place within a fluid, and that adhesion forces resulting from a thin fluid film develop between a gripper (108; 208) and the substrate to be separated (102; 202) that enable adherence to the gripper (108; 208).

Through unloading perpendicular to the feed direction (105; 205) or particularly in parallel to the planar design of the substrates (102; 202), a very gentle and efficient separation of disc shaped substrates (102; 202) is possible with a short cycle time.

Apparatus and method for separating and transporting substrates The invention relates to an apparatus for the separation and transportation of substrates. The substrates are disc shaped and fragile. For separation, there is provided a carrier device that takes up the single substrates in the formation of a substrate stack and keeps them ready for the separation. An unloading device carries out the process of separation and transportation.

The invention further relates to a method for the separation and transportation of substrates that are being provided in a substrate stack.

The “substrates” are disc- or plate-shaped and usually rectangular. They are obtained from a substrate block subjected to a sawing process. They have continuous edges that are substantially straight, wherein the corners can be of a rectangular, a rounded, or chamfered shape.

A “substrate stack” defines a plurality of substrates that are stacked onto each other or arranged side by side or one after the other. According to the invention, a stack in which the substrate surfaces are horizontal is referred to as a “laying” stack of substrates laying one onto the other; if the substrate surfaces are vertical, this corresponds to a “standing” stack of substrates standing side by side. The individual substrates are already detached from a holding means that is necessary for the sawing process, and stacked free and independent from each other. Unintentionally, however, the individual substrates often still adhere to their mutual surfaces due to the previous sawing process. For the further processing, it is usually necessary to separate these so stacked substrates. This means that the substrate that is provided at the end of an upright positioned substrate stack shall be removed with an apparatus from the substrate stack and transferred into the further treatment process.

The “stack direction” of the substrates within a substrate stack is determined by the position of the substrate to be separated. The individual substrates are oriented such that they are substantially standing with their surfaces being contiguous to one another. For the special case of exactly and entirely contiguously oriented substrate surfaces, the stack direction corresponds exactly to the direction of the surface normal of the substrate(s), wherein the positive direction points to that end of the stack from which the next substrate to be separated shall be taken. If this substrate is positioned at the right side of the “standing” substrate stack being arranged within the carrier device, the staple direction thus points to the right in arrow direction.

The “feed direction” of a stack substantially corresponds to the stack direction.

The “stack start” denotes that end of the substrate stack, at which the next substrate to be separated is located. This is that end that points in feed direction. However, if it is generally referred to a “stack end”, this does not clarify whether the stack start or the opposite end of the stack is meant.

The substantially perpendicular or upright positioned substrate stacks are provided in a “carrier device” with one edge of each substrate being supported on the carrier device. The carrier device picks up the substrate stack for example after sawing and/or removing of the glue that is often used in order to fix the initially unsawed substrates onto a holding plate, and transports it to an unloading device where separation shall take place. The carrier device preferably is designed such that it takes up the substrate stack as a whole, i.e. the individual substrates substantially stand contiguously next to each other or one after the other, respectively.

If desired, the carrier device can allow for or enforce a certain tilt against the original stack direction of the substrates contiguously touching each other, so that a constructively predetermined “tilt angle” of the substrates with respect to the original stack direction results that is named a in the context of the present invention. This angle is enclosed by the surface normal of a substrate and the feed direction, wherein the surface normal of that substrate surface has to be chosen that points more towards the feed direction, so that tilt angles between −90° and +90° can occur. Positive angles indicate a backward tilting of the substrates (opposite to the feed direction); negative angles indicate a forward tilting of the substrates (in feed direction). Preferred tilt angles are in the range of +5° to +35°; particularly preferred are tilt angles of +15° to +20°.

According to the invention, “adhesion” means forces that act between two surfaces and evolve from the approach of these two surfaces to one another. Since the adhesion forces described according to the invention shall develop within a fluid, it is necessary that the fluid volume located between the two surfaces is reduced, what, in general, can be achieved by displacement and/or through extraction by suction. In order to comply with the object of the invention of an as much as possible gentle handling of the substrates, the reduction of the volume is only carried out to the extent that a fluid- or liquid film remains between the surfaces.

The “unloading device” serves for the separation and transportation of a substrate away from the substrate stack. Here, the substrate that is located at the one end of the substrate stack is picked up by the unloading device, for example using suction devices, detached from the substrate stack and thus separated, and fed into a subsequent treatment or transportation process. The unloading device serves for dislocating the substrate to be separated from the substrate stack, whereby the “unloading” can be effected in multiple directions. On one hand, unloading can occur in stack direction, i.e. the substrate to be separated is picked up by the unloading device and pulled away in stack direction and parallel to the planar shape of the subsequent substrate, so that tensile or compressive forces occur between the substrate to be separated and the subsequent substrate due to existing adhesion. On the other hand, the substrate may be removed by displacement with respect to the subsequent substrate, so that only shear forces develop between the two substrates. In this case, the substrate to be separated is shifted or removed upwards in direction of the planar extension of the substrate, preferably approximately perpendicular to the plane of the carrier device.

Depending on the unloading direction, different forces of different magnitude act on the substrate to be separated and the substrates still located in the stack, whereby these forces particularly act on the substrate following the substrate just being unloaded.

For separation of the substrate stack it is intended that the stack together with the carrier device is arranged within a fluid, whereby it has to be understood that this means substantially liquid media. Within the fluid, “flow devices” are provided that blow the fluid against the substrate stack from one or the side(s) and/or from below or above, respectively. This takes place in such a manner that a flow is achieved that is directed to the substrate stack and results in “fanning” of the individual substrates and keeping them in a distance to each other. This means that between the individual substrates an interspace develops that is filled with fluid.

According to a preferred embodiment, this fanning can be supported with additional suitable means, e.g. with ultrasonic transducers particularly positioned in the fanning region. This is particularly advantageous if the adhesion forces between the substrates touching each other are so strong that, otherwise, an entrance of the fluid would only take place very slowly.

A “position detection device” serves for detecting the position and/or the location of the substrate to be separated and/or of the substrate stack. Provided that an appropriately arranged electronics with a sensor receives a signal that is equivalent with the substrate to be unloaded being arranged in a proper position and location, operation of the unloading device is enabled for separation. If the substrate to be separated does not lie against the position detection device in a proper position and location, a different signal is generated and must then be interpreted accordingly. The position detection device can furthermore be used for moving the substrate to be separated by the use of suitable, e.g. geometrical, constraints into the desired position that is necessary for the release of the signal for the unloading device, and/or for holding the substrate there.

In one of the known production methods for substrates that are for example be used in the production of solar- or semiconductor wafers, silicon blocks or silicon columns (herein referred to as substrate blocks) are used, that are sawed in thin, fragile wafers (herein referred to as substrates). The substrates produced in this way have typical thicknesses of some 10 to 300 μm and are usually of a quadratic or rectangular shape. Preferably, they then each have an edge length of up to 210 mm.

For sawing, the substrate blocks are usually glued onto a holding means. This holding means typically consists of a metal carrier, onto which a glass plate is mounted as an intermediate carrier, whereby the substrate block to be treated is glued onto the glass plate. Alternatively and according to the prior art, also other materials can be used for the construction of the holding means.

For the fabrication of the substrates mentioned before it is necessary to completely saw through the substrate block in a disc like manner, so that the cut itself extends beyond the substrate block into the glass plate. After sawing the substrate thus produced still adheres with its one edge to the glass plate via a fastening with adhesive. After the substrate block is completely separated into individual substrates, a comb like object is formed.

Before the individual substrates now having a disc shaped geometry are detached from the holding means, a pre-cleaning usually takes place.

For carrying out the sawing process a medium is required that substantially comprises glycol and, if necessary, further chemical additives as well as a separating agent, e.g. such as silicon carbide grains. This medium is called “slurry” and serves for carrying out the sawing process. Normally, a certain residue of slurry always remains in the space between the individual sawed substrates. In the worst case, during the treatment or subsequent to it, the slurry becomes paste-like, since it mixes with the silicon particles from the substrate block as well as with the wear debris of the sawing wire being used in the sawing process and the separating agent, or because certain components of the admixture react with each other. Due to its consistency, the slurry adheres to the surface of the wafer. Despite of a pre-cleaning that normally follows the sawing of the substrate blocks, very often residues of the admixture can be found between the substrates.

WO 01/28745 A1 discloses methods and devices for the detachment of disc shaped substrates, wherein the separation takes place in the dry, i.e. outside of a liquid bath. A wetting of the substrates can only occur by nozzles. A robot-like device grips the substrate to be detached via suction devices (active generation of a gas vacuum e.g. by a vacuum pump), whereby the substrate is detached from the holding means by an oscillating movement of the device. Oscillating movements in different directions are enabled. Gripping of the substrate to be separated takes place by aid of a suction device that is arranged above the surface of the substrate and fixed to the device. For release of the substrate, a certain gas over pressure is generated within the suction device so that the detached substrate can again be removed from the device.

DE 199 00 671 A1 discloses methods and devices for the detachment of disc shaped substrates such as, in particular, of wafers. It is proposed that the substrates that adhere to each other directly subsequent to the sawing process and that are still fixed with their one side (edge) to the holding means are kept in a distance to each other by a well-directed fluid jet. A wedge device serves for the separation of the substrate to be detached from the holding means. At the same time, the separated substrate is removed from the holding means by a gripper arm like device having suction means.

DE 697 22 071 T2 discloses an apparatus for the placing of wafers that have been obtained by sawing of a substrate block into a storage element. Handling devices are proposed that allow for gripping of round or square cross sectioned substrates and for transferring them into a stand like object. In doing so, several substrates are picked up simultaneously and transferred to a placement area that receives the separated substrates.

DE 199 04 834 A1 discloses an apparatus for the detachment of single thin, fragile and disc like substrates. The substrate block with the already sawed substrates is located within a tank filled with fluid. In contrast to the prior art, the holding means together with the substrates that are still fixed to the holding means is arranged vertically, so that the substrate to be separated is arranged parallel to the fluid surface. A wedge device causes the substrate to be separated being detached from the glass plate. A conveyor belt that is arranged in close proximity to the substrate serves for the transport of the detached and floating substrates. A pushing device ensures that the holding means is always brought in the same position and horizontally moved against the wedge device for the detachment of the respective substrate. On the other side of the conveyor belt a device is provided for the automatic insertion of the separated substrates into a stand. Aim of the detachment is that the separated, disc like substrates are stacked after being removed from the holding means and inserted in predetermined devices or placed directly and contiguously on top of each other.

EP 0 762 483 A1 also discloses an apparatus that is, inter alia, capable of separating planar substrates. The already separated substrates are provided in a carrier device, where they for the time being touch each other with their surfaces. For separation and transfer into a container the substrates are transported away from the stack using a pusher and, if desired, by the aid of rollers and/or fluid jets, wherein it is imperative that the substrates are in a horizontal, i.e. lying position. According to the previous clarification, the substrates are thus arranged in the form of a “lying” stack of substrates lying upon each other. Alternatively, the document discloses a separation by use of a suction gripper that must be supplied with a gas vacuum during the entire gripping- and transporting process, and that directly touches the substrate, i.e. with no protecting fluid film between gripper and substrate surface.

However, the as much as possible gentle separation of the respective substrates according to the art is difficult and suffers from a series of disadvantages.

If it is desired to omit manual operation, movements are necessary for the separation and require complex devices. However, since the substrates are very fragile and thin, plate like substrates, these cannot be picked up offhand with common gripper like systems. Hence, it is necessary to provide very precise and sensitive devices.

Accordingly, the state of the art substantially discloses such devices that grip the respective substrate by means of a suction device. Directly after the suction device has been moved toward the planar surface of the substrate to be separated, a gas vacuum is generated by a vacuum pump between suction device and substrate to be separated, so that an attachment of the substrate to a handling device is possible. However, care must be taken since the substrate to be separated can break because of the low pressure being too high.

In contrast to these methods in which a vacuum or a low pressure of least 1 mbar has to be adjusted between two surfaces, the adhesion according to the invention upon maintenance of a fluid- or liquid film is effected by a low pressure that is much weaker than a vacuum and ranges between 0.3 and 0.5 bar, and preferably is approx. 0.4 bar.

In doing so, another critical point arises from the fact that the respective substrate must be approached, i.e. contacted by the handling device. Since the substrate may not in any case be pushed away by the device, an exact positioning is necessary. However, this is difficult, since on one hand, there is provided a relative movement of the holding means for positioning of the substrate to be separated in the region of the holding means, thus providing the holding means itself corresponding degrees of freedom. Therefore, tolerances are possible that result in a possible damage of the substrate to be separated. On the other hand, such movements usually take place within a fluid, so that the substrates run the risk of being dislocated or even broken by a flow pressure that results from the individual movements of the devices, especially towards the substrates.

A separation carried out manually involves the risk that the very thin and fragile as well as disc shaped substrates break, in particular because of the increased adhesion forces.

The object of the invention is therefore the provision of devices and methods enabling a removal of thin, fragile and stacked substrates almost free of damage.

The fundamental idea of the invention is to provide a carrier device on which a substrate stack is located with the substrates being sequentially arranged one after another in feed direction, and an unloading device, with the characteristic that the unloading device grips the respective substrate that is arranged at the stack start of the substrate stack at its surface pointing away from the substrate stack, slightly dislodges it from the following substrate, and then guides it parallel to its planar surface away from the substrate stack and thus away from the carrier device. In doing so it is fundamental that a stream generated by nozzles flows through the substrate stack being arranged within a fluid, through which in particular the substrates that are arranged at the free end of the substrate stack are kept in a distance from each other. In this manner, an adherence of the substrates to one another is avoided. At the same time, this stream results in the formation of a fluid damping cushion between the individual substrates, so that a damping effect acts on the substrate to be separated during the approach of the unloading device, and breakage of the individual substrates can be avoided. A gripper arm of the unloading device grips the substrate to be separated with a gripper in such a manner that the fluid being present between the gripper and the substrate is sucked away to a great extent via boreholes or perforations provided in the gripper and/or squeezed out through approaching, so that, upon development of a sufficiently small interspace, adhesion forces occur that are maintained without further suction and/or squeezing, so that the gripper causes a planar adhesion force acting on the substrate.

Therefore, the solution of the task consists in providing an apparatus according to claim 1 and/or a method according to the features of claim 16.

One of the basic advantages of the invention relies in the fact that the substrates can be completely and automatically separated safe from breakage in a fast cycle.

The basic idea of the solution is that the substrates that are substantially aligned perpendicular but slightly tilted at an angle to the feed direction are fanned within the substrate stack by a flow device. Preferably, flows generated by flow nozzles pass between the first five to ten substrates, so that the individual substrates are held in a distance to each other and so called fluid damping cushions develop between the individual substrates. If a force acts on the substrates opposite to the stack- or feed direction, the individual substrates are, in the course of the method according to the invention, not further compressed; rather, a counter force is generated completely over the entire surface that still allows for a residual movability within certain limits, in particular for the substrate located at the stack start. This counter force is exploited together with the residual movability in order to enable the gripper of the unloading device to push against the substrate to be separated. Without indirect damping by means of the fluid damping cushion located between the fanned substrates the substrate would break with high probability.

Concerning a standing stack, it is preferred that the gripper is inserted from above, i.e. in parallel to the longitudinal extension of the respective substrates and therefore approximately perpendicular to the stack direction, and then guided against the substrate to be separated. According to a preferred embodiment, the boreholes or perforations preferably being present in the gripper serve for suction of the fluid out of the space between the gripper and the substrate to be separated. For this purpose, it is necessary to have an active low pressure that can be generated inside or outside of the apparatus by dynamic methods (e.g. a pump), static methods (low pressure vessel) or other methods. If eventually gripper and substrate are in direct contact so that only a very thin fluid film (some nanometers up to 50 micrometers) is present between gripper and substrate, adhesion forces build up in the close interspace that allow from now on for self-acting adherence or adhesion of the substrate to the gripper. Maintenance of the active low pressure is no longer necessary.

According to an alternative embodiment, the desired adhesion can also be effected by squeezing out the fluid from between the surfaces by approximation of the same, wherein the invention also envisages a combination of these embodiments.

These adhesion forces are particularly greater than those to the following substrate, so that the unloading of the substrate to be separated with the gripper can be effected parallel to the surface direction of the following substrate. In doing so, at the most only minor shear forces act onto the substrate to be separated, thereby considerably decreasing the breakage rate. Tensile or compressive forces are avoided. Given a surface contact that is large enough, the adhesion forces are greater than the forces being generated by the temporary low pressure. Unloading from the substrate stack with a high frequency is possible. Furthermore, the adhesion forces are of such a magnitude, that they, depending on the geometrical design of the gripper and the substrate weight, still allow for adhesion of the substrate to the gripper even without generation of active low pressure, in particular when the substrate is located outside of the fluid surrounding the substrate stack. Here it must be taken into account that the functional interrelation of borehole diameter and number within the gripper surface, the dimension of the gripper surface, as well as the magnitude of the low pressure that is necessary for sucking off the fluid and suction-caused attraction of the substrate are considered.

The gripper itself is preferably arranged in such a manner that is consists exclusively of a beam. According to alternative embodiments, the grippers can be bar-shaped, finger-shaped, o-shaped, unshaped, triangular and spiry pointing in the gripper moving direction (v-shaped), or have a 2-dimensional design. The gripper can be constructed substantially rigid as well as substantially flexible. Particularly preferred are such embodiments that exhibit a low flow resistance in the gripper movement direction and/or produce as little turbulences as possible when removing the substrate from the substrate stack and during the subsequent separation motion. The grippers of all embodiments additionally have the advantage that only one gripper can be used for different formats of substrates, and that the principle of gripping the substrate to be separated can properly be carried out even on such substrates that are already broken and thus do no longer have the normal dimensions. Another advantage relies in the fact that different formats of substrates can be picked up with one gripper embodiment. This is due to the fact that no suction effect, but rather an adhesion force is achieved that extends in a planar manner over the contact surface between gripper and substrate.

According to a further embodiment, the gripper can also be designed as a flexible band made from a suitable material such as e.g. plastic, wherein the band is most preferably designed in such a manner that its surface is passable for the fluid, so that the fluid both can be sucked and emitted as well as displaced. For this purpose, openings in the form of boreholes as well as in the form of a porous basic material can be provided. The low pressure that is necessary for the suction can be provided by a substantially stationary device that is arranged at the end of the substrate stack and attaches the free reverse side of the band at the beginning of the gripping process and draws off the fluid through the openings until the front side of the band and the substrate to be gripped have come sufficiently close to each other. After creation of an adhesion as mentioned before, the band can transport away the now adhering substrate, wherein the thin fluid film is maintained at all times.

According to the invention, the low pressure is generated at the beginning of the unloading phase. Even if this low pressure must only be maintained until the afore-mentioned fluid film between substrate and contact area of the gripper is obtained, the low pressure may as well be maintained until the deposit of the substrate onto the transporting device.

The carrier device itself is designed in such a manner that it can take up at least one substrate stack consisting of a plurality of substrates or wafers, respectively. Further, the carrier device has means ensuring that the individual substrates exhibit a certain tilt, wherein the tilt is such that the tilt angle α that is enclosed between the stack's feed direction and that surface normal of a substrate that points more towards the feed direction is greater than 0 degrees, i.e. positive. In the case of a standing stack this means that the edge of the substrate that lies on the carrier device is, in feed direction, arranged in front of its upper edge. This involves the advantage that the gripper can plunge into the fluid parallel to this orientation and remove the substrate in this plane as well. Through this, it is also avoided that the standing stack tips forward during a transfer of the carrier device within the fluid, resulting in a loss of its orientation.

Thus, the carrier device is moveable in at least one direction. Preferably, it is moveable in feed direction; to be precise, firstly so far until the first substrate to be separated of the substrate stack arrives at the position detection device. Afterwards, it is e.g. moveable in steps, wherein the step width preferably corresponds to the respective substrate thickness that normally is constant over the stack; to be precise, so far until eventually the stack's last substrate is brought up to the unloading device. Alternatively, the carrier device can be designed stationary. In this case, suitable means would be provided with which the substrate stack can be moved in feed direction on the carrier device. Alternatively or additionally, the gripping device as well as the position detection device may have greater degrees of freedom at their disposal, so that they are moveable opposite to the feed direction in direction of the stack start.

The position detection device is a device for the detection of the position and location of the substrate to be separated. For this, it is provided that the position detection device comprises pressing pins that are oriented in direction of the substrate stack. By decreasing the distance between the position detection device and the substrate stack, the fanned start of the substrate stack is adjusted until the substrate to be separated bears against all pressing pins provided. An additional sensor element, i.e. in the form of a touch sensor, emits a corresponding signal, by which the gripper can now plunge preferably between the pressing pins and separate and transport the substrate to be separated.

In case the substrate stack comprises substrates with a thickness exceeding the average thickness that is set for the adjusting of the pressing elements and therefore the resulting step width, this condition is detected by the position detection device, so that the substrate stack is accordingly moved in feed direction until the next substrate to be separated contacts the pressing elements.

Alternatively or additionally, the position detection device can further comprise a protractor. In this way, the exact position of the substrate to be separated can be determined and optionally be used as quantity for quality verification of the substrate to be separated.

Thus, the advantage of the apparatus is that by interplay of carrier device, unloading device, flow device as well as position detection device, an apparatus particularly suitable for the separation and transportation of substrates has been created, by which the procedural steps can be carried out automatically and with an extremely low breakage rate compared to the state of the art. This advantage is supported by the fluid damping cushion as provided and based upon the flow device.

Furthermore, the design of the unloading device itself as well as the hence predetermined removal of the substrate perpendicular to the stack direction have the effect that no or only weak tensile or compressive forces act on the substrate to be separated. Advantageously, this unloading device is designed in such a manner that the removing occurs parallel to the planar extension of the respective substrate, so that as little as possible tensile, compressive or bending forces act on the substrate. The gripper can be in the form of a single gripper as well as a band.

The further transport occurs preferably within the fluid. However, it is also envisaged that the gripper is brought out of the fluid and that the gripper deposits the substrate that is attached by means of adhesion onto a transporting means such as e.g. a conveyor belt in such a manner that fluid is emitted in direction of the substrate through the boreholes provided in the gripper, so that the planar-shaped substrate can come off the gripper easily and without the effect of tensile and/or compressive forces acting on it from the outside.

The cycle is indefinitely repeatable.

One of the basic advantages of another embodiment of the invention is that the gripper can exhibit a certain tolerance in its approach to the substrate. It is not necessary that the gripper stops exactly in front of the substrate to be separated and that it is positioned there. Rather, the damping that develops due to the arrangement of the substrates within the fluid as well as to the flow device can advantageously be used in that the gripper moves with little force contrary to the feed direction against the substrate stack, thereby establishing a planar contact to the substrate to be separated that is flexibly supported due to the fluid damping cushion located behind.

Another advantage of the invention relates to the provision of an apparatus that enables to automatically use the adhesion forces being present between gripper and substrate, so that each individual substrate relatively independent of its size and outer shape can easily be removed without breakage, even be partly cleaned due to the transport within the fluid, and be transferred to a certain device such as for example onto a transporting device.

A further alternative embodiment of the unloading device relates to a device having a defined degree of flexibility, so that tolerances are compensated between the positioning region with respect to the planar arrangement of the receiving surface and the substrate to be separated. The gripper, the handling device and/or the connection between both components are formulated flexible and thus deformable.

In order to increase the cycle time for the separation, according to a particularly preferred embodiment, a further means is provided for the take-over of the separated substrate from the unloading device. Within the time span in which the substrate is deposited by this further means onto a conveyor belt, the unloading device can already take up a further substrate from the substrate stack. Alternatively or additionally, two substantially identical unloading devices can be provided that are switched off-phase.

Further advantageous embodiments follow from the subsequent description, the claims as well as the figures.

### FIGURES

Depicted are in:

FIG. 1[A-F] a schematic presentation of the inventive principle of the apparatus according to the invention, in particular the procedure of a separation and transportation process of a substrate to be separated;

FIG. 2 a schematic presentation of an embodiment of the apparatus according to the invention as of FIG. 1 in a side view;

FIG. 3 a schematic presentation of the embodiment depicted in FIG. 2 in a perspective view;

FIG. 4[A] a schematic presentation of a first process step of the apparatus according to the invention as of FIG. 2 in a side view;

FIG. 4[B] a schematic presentation of a first process step of the apparatus according to the invention as of FIG. 2 in a perspective view;

FIG. 5[A] a schematic presentation of a second process step of the apparatus according to the invention as of FIG. 2 in a side view;

FIG. 5[B] a schematic presentation of a second process step of the apparatus according to the invention as of FIG. 2 in a perspective view;

FIG. 6[A] a schematic presentation of a third process step of the apparatus according to the invention as of FIG. 2 in a side view;

FIG. 6[B] a schematic presentation of a third process step of the apparatus according to the invention as of FIG. 2 in a perspective view;

FIG. 7[A] a schematic presentation of a fourth process step of the apparatus according to the invention as of FIG. 2 in a side view;

FIG. 7[B] a schematic presentation of a fourth process step of the apparatus according to the invention as of FIG. 2 in a perspective view;

FIG. 8[A] a schematic presentation of a fifth process step of the apparatus according to the invention as of FIG. 2 in a side view;

FIG. 8[B] a schematic presentation of a fifth process step of the apparatus according to the invention as of FIG. 2 in a perspective view;

FIG. 9[A] a schematic presentation of a sixth process step of the apparatus according to the invention as of FIG. 2 in a side view;

FIG. 9[B] a schematic presentation of a sixth process step of the apparatus according to the invention as of FIG. 2 in a perspective view.

### DESCRIPTION

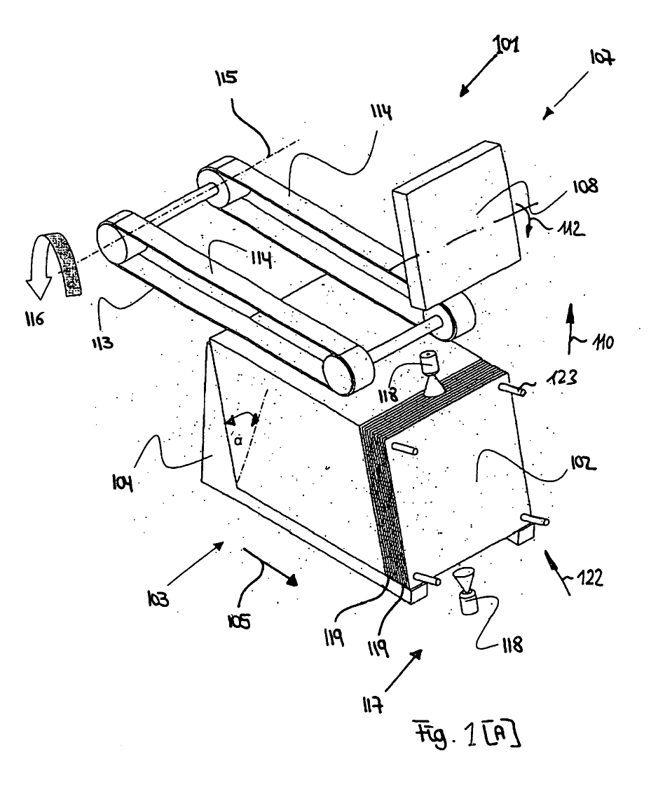

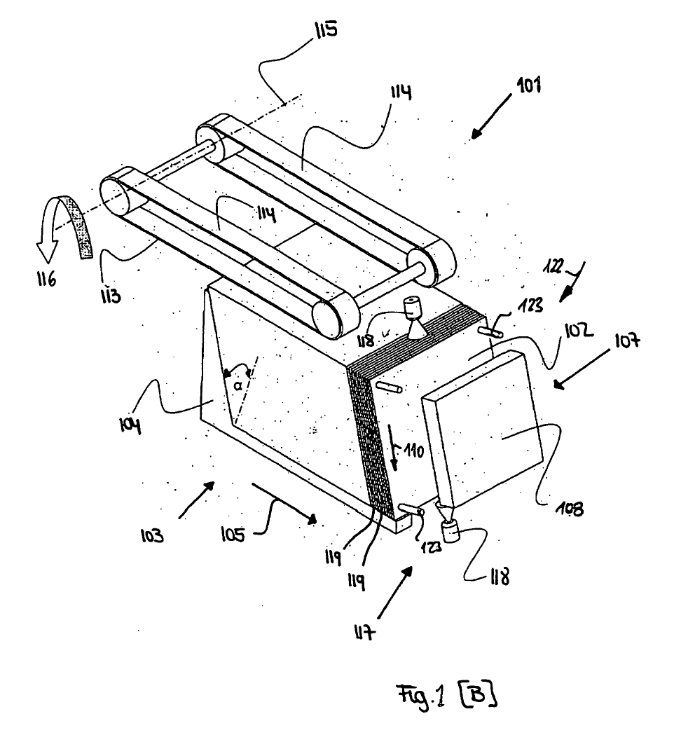

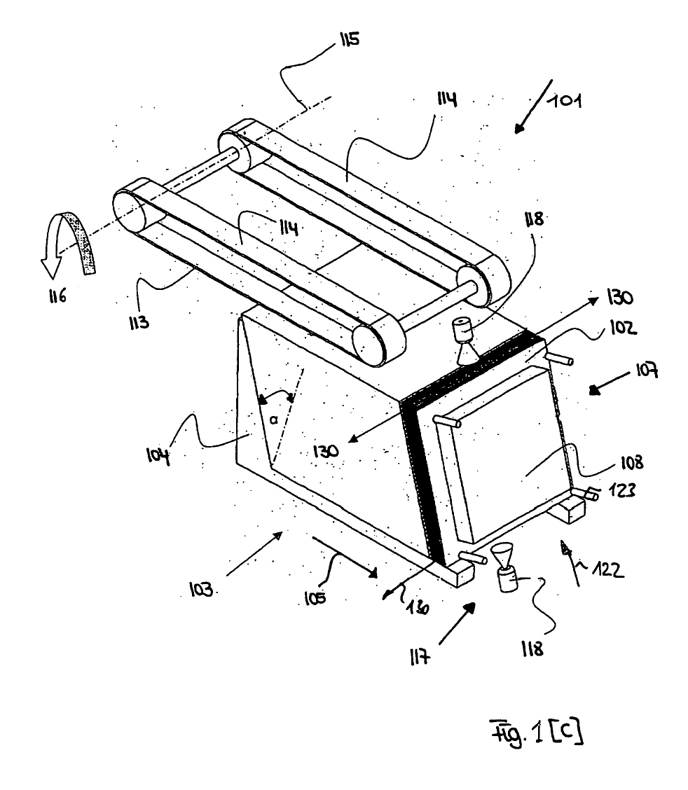

In FIG. 1, drawings A-F, the basic principle of the apparatus according to the invention 101 as well as of the method according to the invention is schematically depicted. This apparatus 101 is suitable for the separation and transportation of disc-shaped substrates 102.

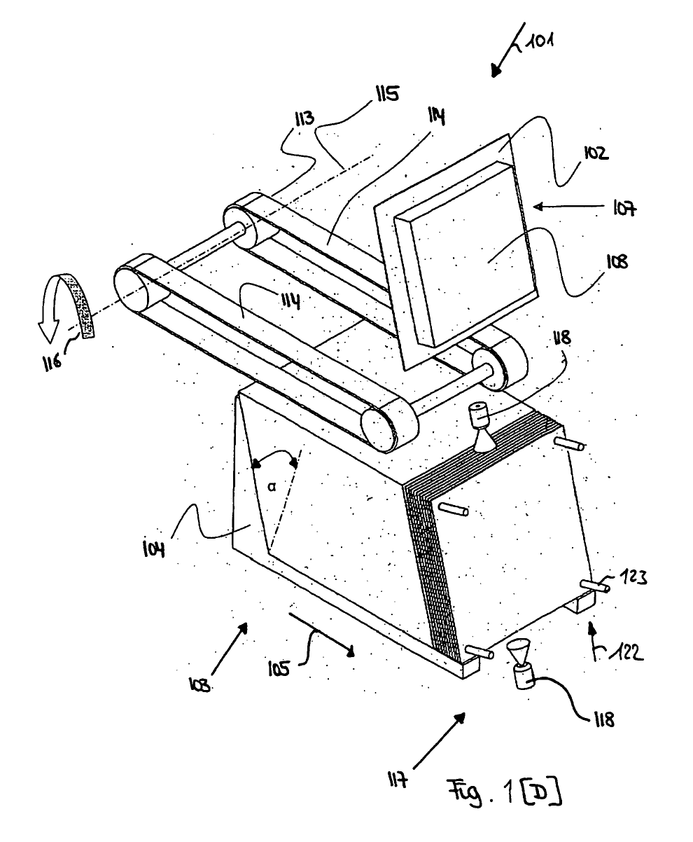

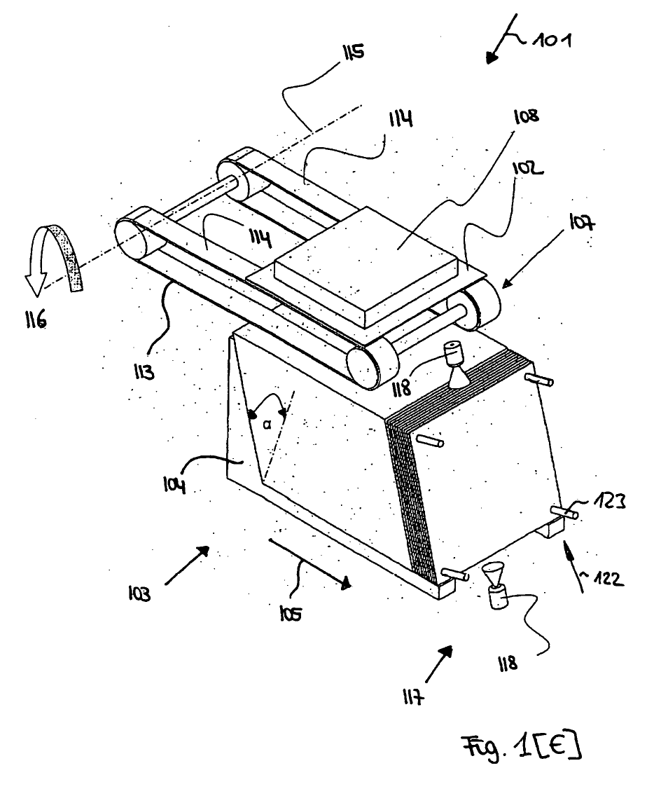

In the exemplary embodiment depicted, the substrates 102 are arranged in a substrate stack 103, wherein the substrate stack 103 is supported in a carrier device 104. The individual substrates 102 are already detached from a holding means. Preferably, the surface normals of the surfaces of the individual substrates 102 pointing more in feed direction are inclined with an angle α (tilt angle) (depicted in FIG. 2) towards the feed direction. Upon arrangement of the apparatus within a fluid this inclination avoids in the case of a standing substrate stack 103 that the individual substrates 102 float or unintentionally leave the carrier device 104. Furthermore, the individual substrates 102 can be taken up more easily by the unloading device 107 that is yet to be described in more detail in the following.

The individual planar-shaped substrates 102 are arranged next to each other in such a way that their surfaces contact each other. Adhesion forces act between them that result from the very small interspace between the substrates and from possible contaminations e.g. from a preceding sawing step. Due to this arrangement the substrates 102 determine a defined feed direction 105.

In the depicted figures, the substrates are shown schematically. Therein, the schematically shown block view means that the substrates in this region are lying very close to each other. In the further region, namely the unloading region, the substrates are fanned and exhibit an interspace. The adhesion forces between the fanned substrates preferably are zero.

Further, according to the invention, an unloading device 107 is provided that is designed gripper-like. It is shown schematically in the exemplary embodiment depicted here, and substantially shows a gripper 108. At the gripper 108, a handling device (depicted in FIG. 1[A]) is arranged which allows to move and/or swivel the gripper 108 in different directions. Preferably, the gripper 108 can be swiveled in direction of arrow 110 and around an axis in direction of arrow 112.

Furthermore, a transporting device 113 is provided. This transporting device 113 consists of a conveying belt 114 that is driven through an axle 115 in the direction of arrow 116.

Preferably, it is provided that at least certain components of the apparatus 101, namely the carrier device 104, the substrate stack 103, as well as parts of the unloading device 107 are arranged within a fluid. Through this, it is achieved that the substrates do not become dry over the duration of the entire process, at least until their deposition onto the transporting device. Optionally, the remaining components of the unloading device 107 as well as the transporting device 113 can also be arranged within the fluid, wherein the transporting device may alternatively also have own means for humidification of the substrates.

For the improvement of the separation of the respective substrates 102 at least one flow device 117 with flow nozzles 118 is arranged through which fluid is injected into interspaces 119, wherein this interspace 119 is located between the substrate to be separated 102 and the following substrate 102. Preferably, the respective interspace 119 is maintained as long as fluid streams out from the flow nozzles 118 into the interspaces 119. Advantageously, interspaces 119 between two substrates 102 develop in a defined region where several substrates 102 are arranged.

In order to avoid that the flow causes the individual substrates 102 to leave the carrier device 104, a pressing element 122 is provided that, in the exemplary embodiment depicted in the figures, substantially comprises pressing pins 123. Upon movement of the substrate stack in feed direction the substrate to be separated presses against the pressing elements 123, so that a counteracting force is exerted to the force that is generated by the inflow of the fluid into the interspaces 119.

In the interspaces 119 so-called fluid cushions develop by which it can be ensured that the individual substrates 102 contacting the respective fluid cushion are held in a distance from each other. Further, these fluid cushions have the characteristic that a damping effect results due to exertion of the counteracting force by the pressing element 122, but also due to the gripper 108 contacting the substrate to be separated 102.

In FIG. 1[B], the gripper 108 of the device 107 is already arranged parallel to the surface of the substrate 102. The gripper 108 moves parallel in direction of arrow 110 and in a further subsequent step towards the surface of the substrate 102; to be precise, so far until it has contacted the substrate to be separated 102, as depicted in FIG. 1[C]. Due to the pressure of contact generated by the gripper 108 when touching the substrate 102, the respective interspace between two substrates 102 is decreased. A damping effect develops due to the arrangement of the fluid within the interspaces 119 present between the respective substrates to be separated. In this representation [C] the boreholes not depicted more closely in the figure are activated within the gripper 108 by generating a low pressure as set forth above. Due to the low pressure the gripper 108 attracts the substrate to be separated 102 until the interspace between the substrate 102 and the gripper 108 is greatly reduced and an adhesion force develops between the contact surfaces. The fanning is supported by the effluence of the fluid from the flow nozzles 118.

The gripper 108 moves with the adhering substrate 102 according to FIG. [D] until it can deposit the substrate 102 onto the transporting device 113. In this process the unity of substrate and gripper must be moved a little opposite to the feed direction 105, so that there is no contacting of the pressing pins 123 with the substrate surface during the subsequent unloading motion. Alternatively, for release of the wafer the position detection device can also be moved a little in feed direction. According to the invention, these two movements can also be combined. According to FIG. [E], the substrate 102 is positioned flat onto the conveyor belt 114. For separation of the next substrate 102, the gripper 108, according to FIG. [F], is moved again in the position shown in FIG. [B].

The adhesion forces that develop during the suction-caused attraction of the substrate to be separated 102 are dimensioned such that they are sufficient for transporting the substrate 102 being taken up by the gripper 108 within the fluid.

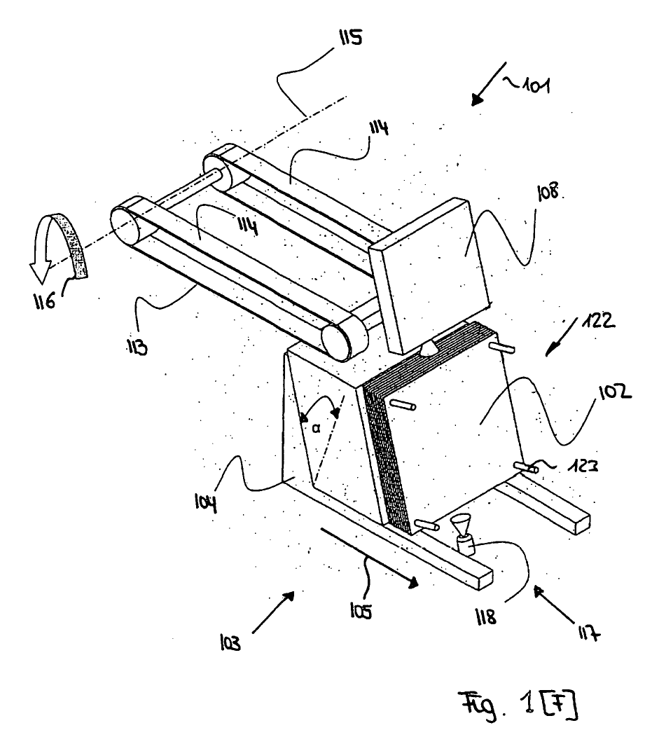

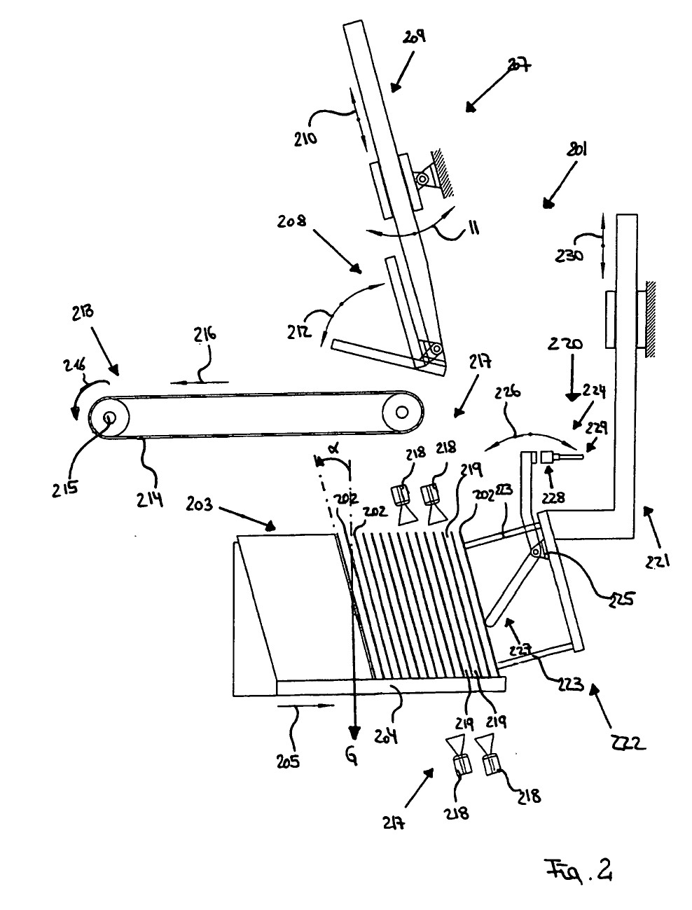

In FIGS. 2 and 3, an apparatus 201 is schematically depicted that shows, in comparison to FIG. 1, a further development of the basic principle.

The apparatus 201 is suitable in particular for the separation and transportation of disc-shaped substrates 202.

In the exemplary embodiment depicted here, the substrates 202 are arranged in a substrate stack 203, wherein the substrate stack 203 is supported in a carrier device 204, and the individual substrates 202 are already detached from a holding means.

Preferably, the individual substrates 202 are arranged with respect to each other by enclosing a tilt angle α (FIG. 2) formed between the feed direction 205 and the surface normal of the surface of the substrate pointing more in feed direction. By this inclination, for an arrangement of the apparatus within a fluid and in the case of a standing position of the substrate stack 203 it is avoided that the individual substrates 202 float and unintentionally leave the carrier device 204. The individual substrates 202 are arranged in such a way that their surfaces contact each other. Thus, the individual substrates form a sequence that determines a defined feed direction 205.

According to the invention, there is further provided an unloading device 207 that is designed gripper-like. It is depicted schematically in the exemplary embodiment shown here and substantially shows a gripper 208. At the gripper 208, a handling device 209 is arranged which allows to move and swivel the gripper 208 in different directions (directions of arrows 210, 211, 212). The gripper 208 and the handling device 209 together form a gripper arm.

Furthermore, a transporting device 213 is provided. This transporting device 213 consists of a conveyor belt 214 that is driven through an axle 115 in direction of arrow 216.

In the preferred embodiment, at least certain components of the entire apparatus 201, namely the carrier device 204, the substrate stack 203 and parts of the unloading device 207 are arranged within a fluid. Through this, it is achieved that the substrates do not become dry over the duration of the entire process, at least until their deposition onto the transporting device. Optionally, also the remaining components of the unloading device 207 as well as the transporting device 213 may be arranged within the fluid, wherein the transporting device alternatively may also have own means for humidification of the substrates.

Further, for the improved separation of the respective substrates 202 at least one flow device 217 with flow nozzles 218 is arranged in the vicinity of the stack start through which fluid is injected into an interspace 219, wherein the interspace 219 develops between the substrate to be separated 202 and the following substrate 202. The flow nozzles 218 are arranged in particular in the region of the substrate stack 203 that is to be fanned. Normally, this applies at least to the first four to nine substrates 202 following the just to be separated substrate 202. Through this, several interspaces 219 develop, wherein each interspace 219 is limited to the right and to the left by a substrate 202. Within the interspace 219, a fluid cushion develops that has damping properties.

Further, in FIG. 2 and FIG. 3 a position detection device 220 is depicted. This position detection device 220 substantially consists of a further handling device 221 as well as of a pressing element 222 that is arranged at one free end of the handling device 221. The pressing element 222 further comprises pressing pins 223 that, according to FIG. 2 and 3, contact the surface of the respective substrates 202 in a defined position, or that bring it in a defined position due to the contacting and hold it there, respectively. The further handling device 221 is moveably supported in and against the direction of arrow 230.

Further, a sensor element 224 is assigned to the position detection device 220. This sensor element 224 has the function of detecting whether a planar contact between the substrate to be separated 202 and the pressing element 222 and/or the pressing pins 223 is present.

A special embodiment of this sensor element 224 is depicted in FIGS. 2 and 3. This sensor element 224 mechanically senses the presence of the substrate to be separated 202. For this, different settings are provided that are detected by a proximity switch 229. The sensor element 224 has a knee-lever like component being supported at a hinge 225 so that it can swivel in and against the direction of arrow 226. The one free end 227 serves for support at the surface of the substrate to be detected 202. The other end 228 is intended for arrangement in the region of the proximity switch 229. The home position of the sensor element 224 is taken when no substrate 202 is detected at the free end 227. The free end 227, via an imaginary line, is arranged between the free ends of the pressing pins 223, and the other free end 228 is designed so that the distance between the free end 228 and the proximity switch is almost zero. As soon as the free end 227 receives pressure the sensor element 224 swivels, and the distance of the free end 228 to the proximity switch increases. If this has taken a position calibrated before, it can automatically be detected whether a substrate 202 is positioned in contact at the free ends of the pressing pins 223. Without pressure at the free end 227 the sensor element 224 moves back into its home position. In alternative embodiments of the sensor element 224 not described in more detail, the detection of the presence and position of the substrate can also be achieved by means of other suitable devices, such as with e.g. optical or acoustical proximity switches, wherein the mechanical transmission of the contact information via knee-lever and hinge 225 can be omitted, where appropriate.

The pressing element 222 preferably is arranged in an angle to the handling device 221 that corresponds to the tilt angle α. Thus, the individual pressing pins 223 preferably are of identical length.

Alternatively, it can be provided that the pressing element 222 is arranged perpendicular to the handling device 221, and that the pressing pins 223 are of different lengths, so that in the depicted position the free ends of the pressing pins 223 always contact the surface of the substrate 202.

The function principle of the position detection device 220 is such that the substrate stack 203 is moved in feed direction 205, more precisely so far until the surface of the substrate to be separated 202 contacts the free ends of the pressing pins 223 of the pressing device 222. When the substrate to be separated 202 is placed in a proper position and location, the sensor element 224 is moved in one of the directions of arrow 226 and the proximity switch 229 detects the correct position.

If the position of the substrate to be separated 202 is correctly positioned, the unloading device 207 can plunge into the interspace formed by the pressing pins 223 and take up the substrate to be separated 202.

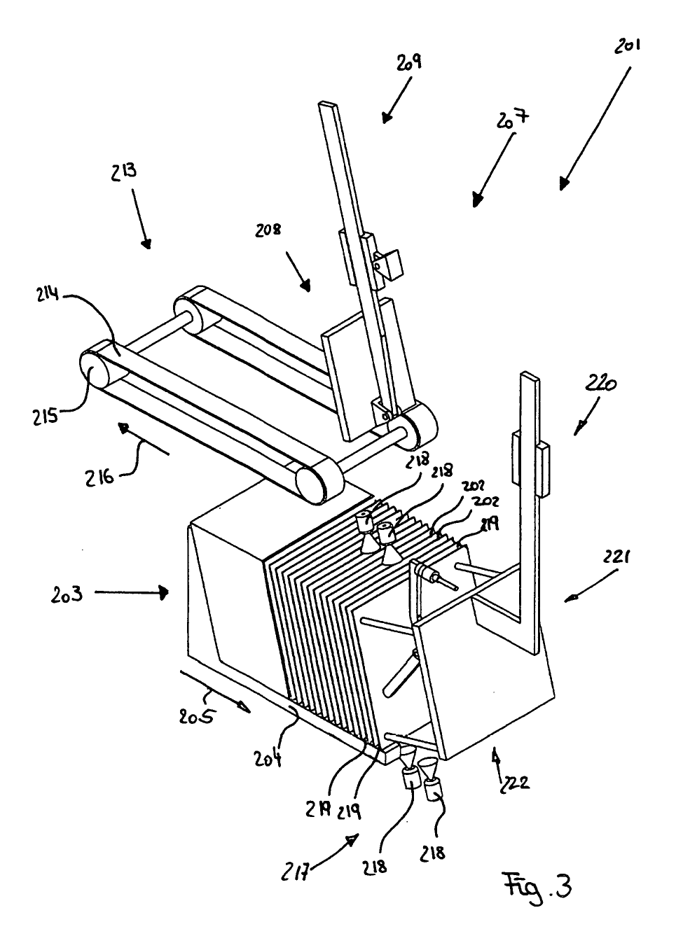

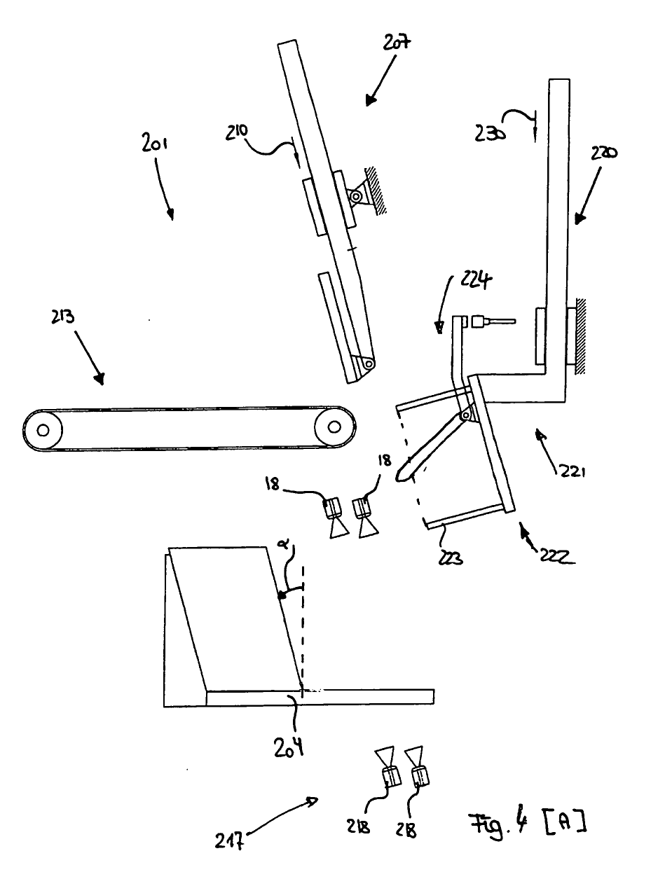

In the following, the individual process steps are explained in more detail by aid of FIGS. 4 to 9.

In FIGS. 4A and B the so called loading situation of the apparatus according to the invention 201 is depicted. The carrying device 204 is ready for reception of a substrate stack only roughly depicted.

The desired tilt angle α of the substrate stack is already preset by according means. The unloading device 207 and the position detection device 220 are in their start position and can be moved in direction of arrow 210 and in direction of arrow 230, respectively. The sensor element 224 that is arranged at the pressing element 222 is in its start position as well and detects no substrate contacting the pressing pins 223.

The gripper 208 of the unloading device 207 is also in an initial position so that it can plunge in between the pressing pins 223 of the pressing element 222.

The transportation device 213 is ready for reception of substrates. The flow nozzles 218 of the flow device 217 are yet switched off.

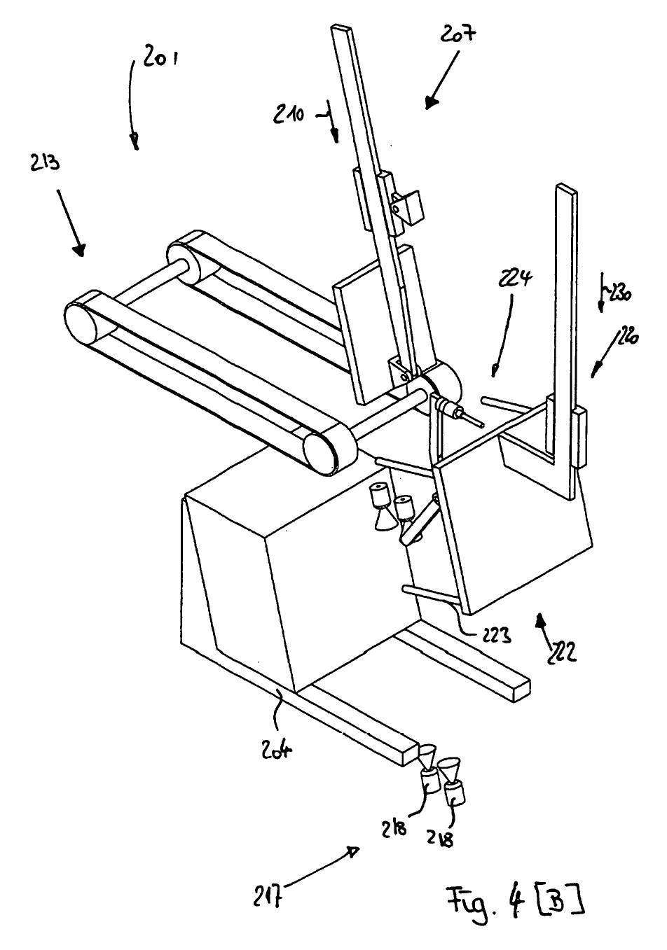

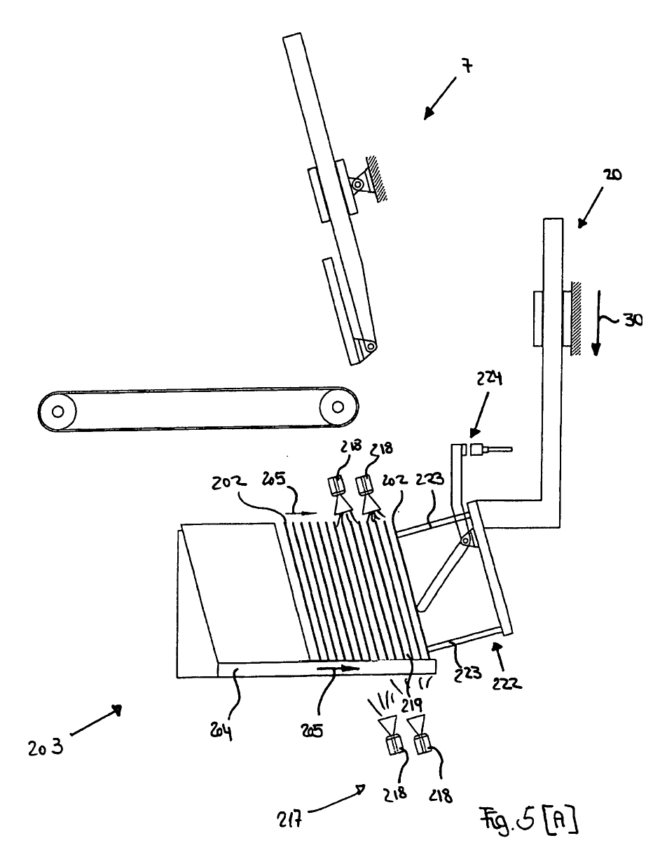

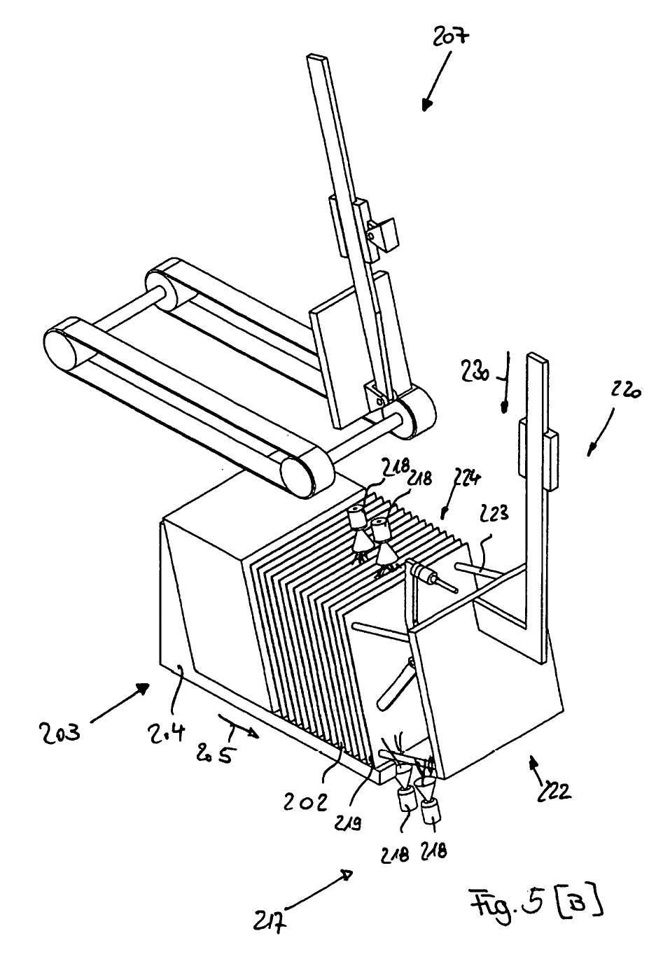

FIGS. 5A and B show that the carrying device 204 is now loaded with the substrate stack 203. This carrying device 204 or the substrate stack 203, respectively, is moved in feed direction 205, i.e. so far until the position detection device 220 that is positioned by movement in direction of arrow 230 has taken a defined position. In this position, the pressing element 222 with its pressing pins 223 contacts the surface of the substrate to be separated 202.

In order to effect a certain position- and profile true orientation of the substrates 202, the flow nozzles 218 of the flow device 217 direct fluid at the substrate stack 203 so that at least a part of the substrate stack 203 fans and gap like interspaces 219 develop. Due to the pressing of the pressing element 222, further fanning of the individual substrates 202 is avoided. This also results in that the substrates 202 remain on the carrying device 204. Provided that the appropriate position of the substrate to be separated 202 is reached by the fanning, the sensor element 224 detects the exact position. If this is not achieved, either the position detection device 220 moves further in direction of arrow 230, and/or the further fanning of the substrate stack 203 is effected. If none of the actions achieve that the sensor element 224 emits an according signal for release of the unloading device 207, a malfunction message is signaled.

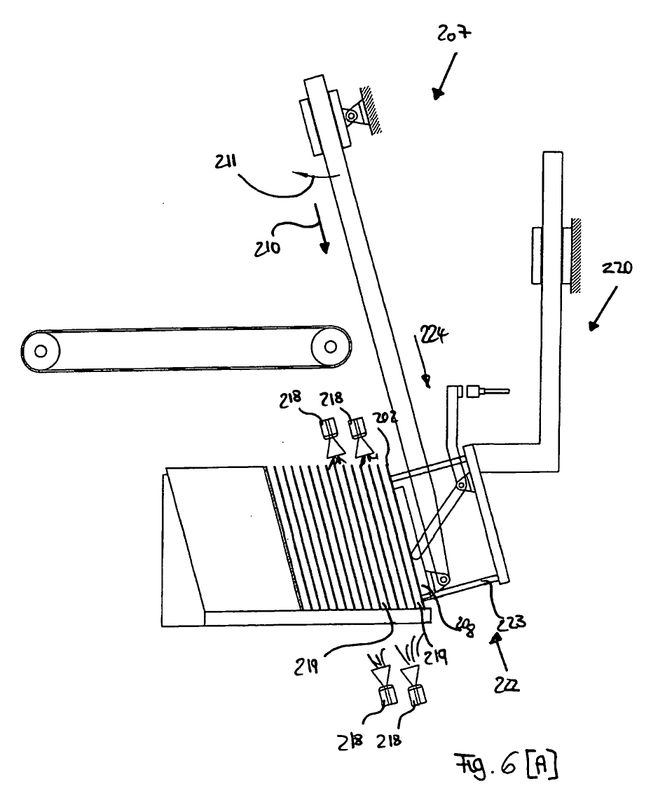

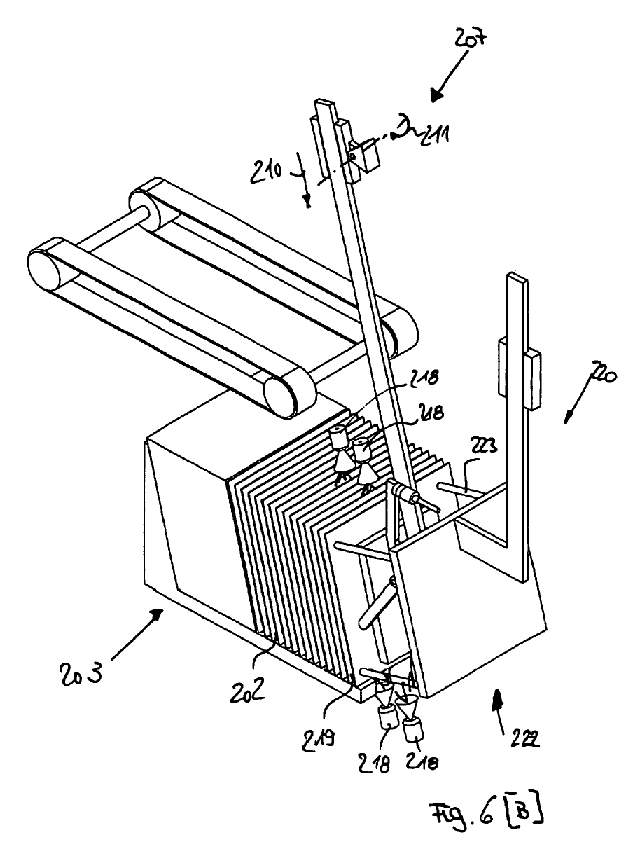

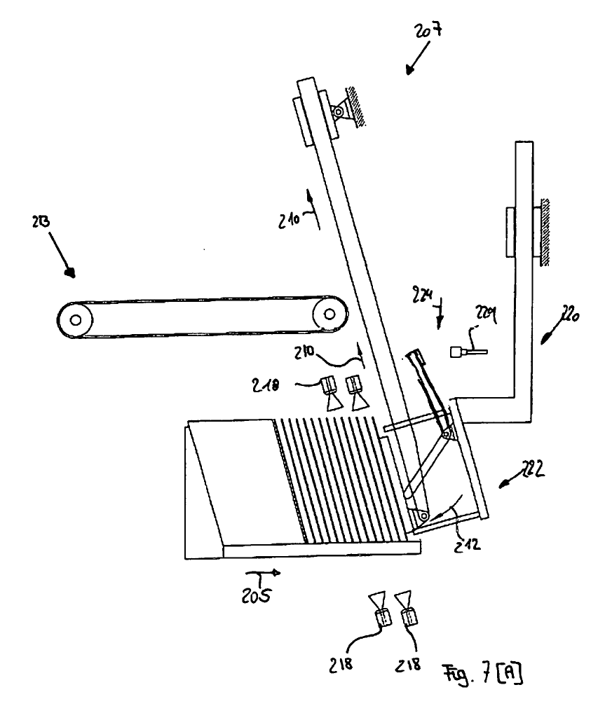

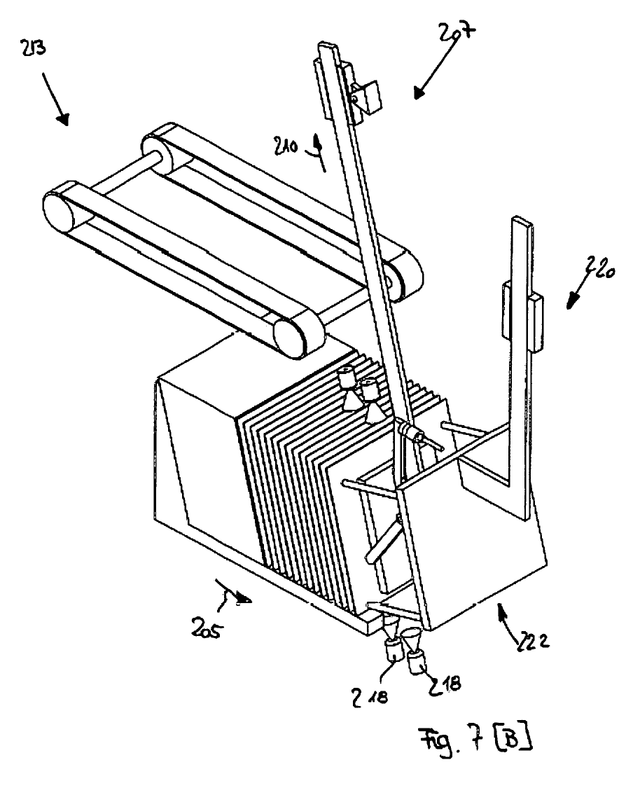

In FIGS. 6A and B the flow nozzles 218 continue to direct fluid into the interspace 219, in particular to achieve development of a so called fluid cushion within the interspaces 219. This fluid cushion serves for achieving an appropriate damping effect between the individual substrates. Now, release takes place due to reaching the intended position of the substrates 202, since the sensor element 224 is swiveled in such a manner that the proximity switch 229 has been activated. The unloading device 207 now moves in direction of arrow 210 in such a manner that the gripper 208 plunges through the space between the pressing pins 223 of the pressing element 222 of the position detection device 220 and reaches the region of contacting the surface of the substrate to be separated 202. By swiveling of the unloading device 207 in direction of arrow 211 a contacting of the gripper 208 to the surface of the substrate 202 is effected. Due to occurring adhesion forces that are particularly intensified because of the low pressure developing between the gripper 208 and the surface of the substrate to be separated 202, the substrate can be moved opposite to direction of arrow 210 as depicted in FIGS. 7A and B. Alternatively or additionally, it is provided that the gripper is swiveled in direction of arrow 212 (FIG. 7A) until a planar contact to the surface of the substrate 202 is achieved. By this, the substrate to be separated is released and can be removed in direction of arrow 210, as depicted in FIGS. 7A and B, in order to subsequently dispose it onto the transporting device 213.

However, in order to avoid damage of the surface of the substrate to be separated 202, either the pressing element 222 is moved backed a little, or the carrying device 204 with the substrate stack 203 is moved backed a little opposite to the feed direction 205, as shown in FIGS. 7A and B. The sensor element 224 swivels back again in its initial position and the proximity switch detects that the substrate to be separated 202 no longer contacts the pressing pins 223.

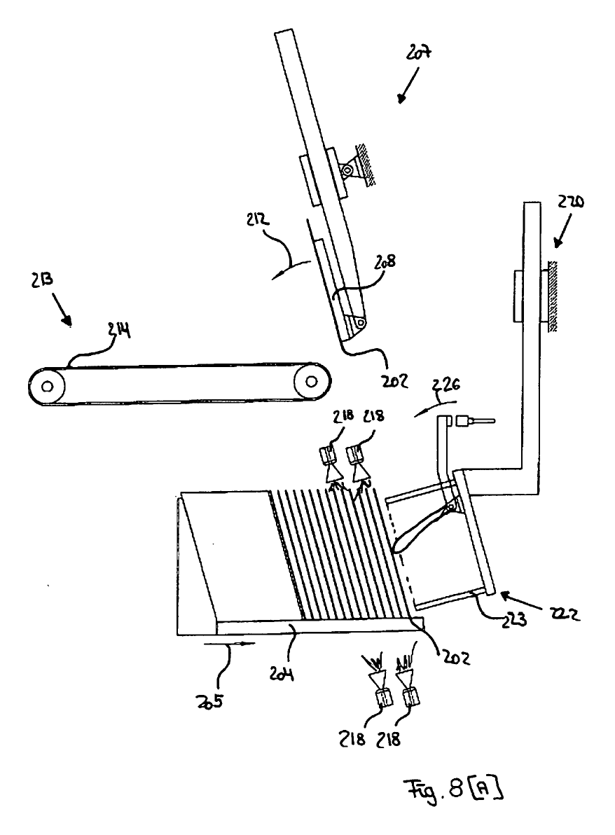

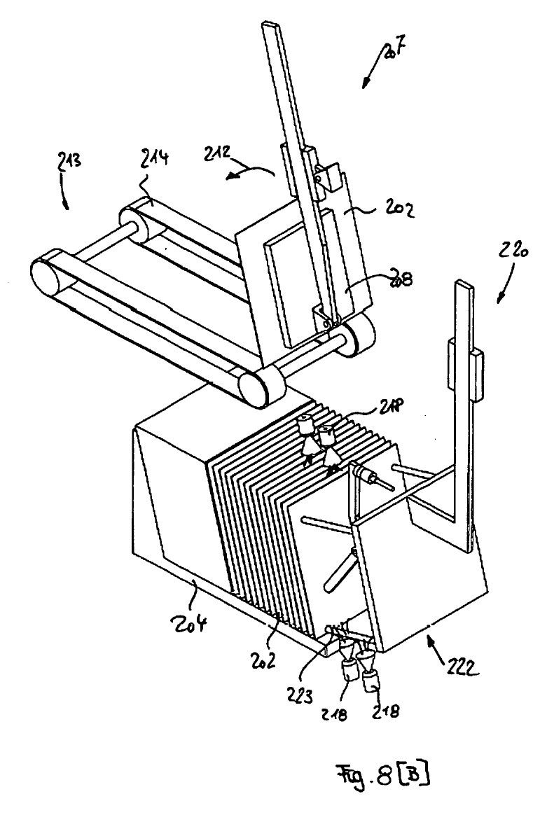

In the time span (FIGS. 8A and B) during which the unloading device 207 or its gripper 208, respectively, swivels in direction of arrow 212 in order to deposit the substrate to be separated 202 onto the transporting device 213 or its conveyor belt 214, respectively, the carrying device 204 with the substrate stack 203 in turn moves in feed direction 205 against the position detection device 220, until a contact is achieved between the substrate to be separated 202 and the pressing element 222 with its pressing pins 223.

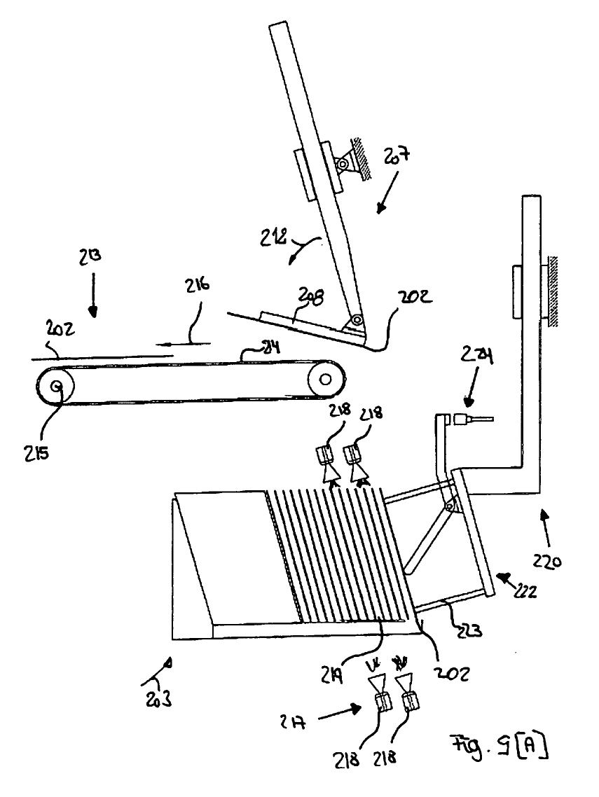

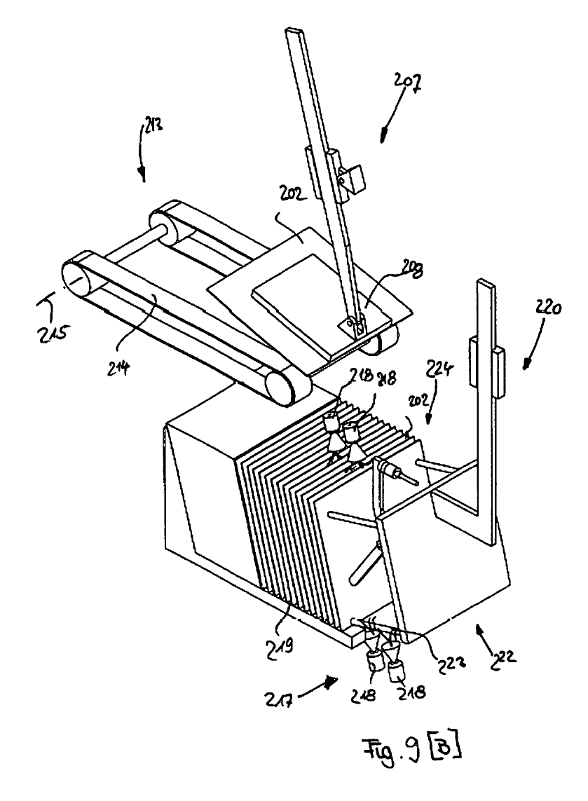

The deposition of the substrate 202 by the unloading device 207 is depicted in FIGS. 9A and B. The substrate 202 is deposited onto the conveyor belt 214 of the transporting device 213 and transported away in direction of arrow 216 by a drive at the axle 215.

Either during this process or subsequently, fluid is again directed into the interspaces 219 of the substrate stack 203 by the flow device 217 or its flow nozzles 218, respectively, resulting in a fanning until the substrate to be separated 202 comes into contact with the pressing pins 223 of the pressing element 222 of the position detection device 220. This causes the sensor element 224 to generate the release signal for the pickup of the substrate to be separated 202 by the unloading device 207. In this manner, the process is repeated as often as necessary.

As soon as no more substrate 202 is present in the substrate stack 203, the absence of substrates 202 is detected by the pressing element 222 or the sensor element 224, respectively, and an appropriate malfunction message is signaled.

The adhesion forces that develop during the suction caused attraction of the substrate to be separated 202 are dimensioned such that they are just sufficient for transporting the substrate 202 that is taken up by the gripper 208 within the fluid.

The present invention was explained in regard of the treatment of silicon wafers. As a matter of course, disc shaped substrates made from other materials such as plastics can also be treated according to the invention.

list of references

| | | |
|---|---|---|
| 101 | 201 | apparatus |
| 102 | 202 | substrate |
| 103 | 203 | substrate stack |
| 104 | 204 | carrying device |
| 105 | 205 | feed direction |
| | 206 | bore holes |
| 107 | 207 | unloading device |
| 108 | 208 | gripper |
| | 209 | handling device |
| 110 | 210 | direction of arrow |
| | 211 | direction of arrow |
| 112 | 212 | direction of arrow |
| 113 | 213 | transporting device |
| 114 | 214 | conveyor belt |
| 115 | 215 | axis |
| 116 | 216 | direction of arrow |
| 117 | 217 | flow device |
| 118 | 218 | flow nozzles |
| 119 | 219 | interspace |
| | 220 | position detection device |
| | 221 | additional handling device |
| 122 | 222 | pressing element |
| 123 | 223 | pressing pins |
| | 224 | sensor element |
| | 225 | hinge |
| | 226 | arrow |
| | 227 | free end |
| | 228 | other free end |
| | 229 | proximity switch |
| | 230 | direction of arrow |
| α | α | tilt angle |

1. Apparatus for the separation and transportation of disc shaped substrates, wherein the apparatus substantially comprises the following assembly groups:
a carrying device (104; 204) arranged within a fluid, in which the individual substrates (102; 202), in feed direction (105; 205), are sequentially arranged standing one after another in the form of a substrate stack (103; 203),
an unloading device (107; 207) for the separation and transportation of at least one substrate (102; 202), wherein the unloading device (107; 207) comprises a gripper (108; 208) with means by the aid of which the substrate (102; 202) can be taken up and guided away from the carrying device (104; 204),
a flow device (117; 217) for fanning of at least a part of the substrate stack (103; 203), and
a pressing element (122; 222) that acts against the fanned substrates (102; 202).

2. Apparatus according to claim 1, characterized in that the pressing element (122; 222) comprises a plurality of pressing pins (123; 233) that press against the surface of the substrate to be separated (102; 202).

3. Apparatus according to claim 1, characterized in that a position detection device (220) is provided for the detection of the position and/or location of at least the substrate to be separated (202).

4. Apparatus according to claim 1, characterized in that the gripper (108; 208) is designed such that the removal of the substrate to be separated (102; 202) takes place perpendicular or at least approximately vertical to the feed direction (105; 205).

5. Apparatus according to claim 4, characterized in that the removal takes place in parallel to the surface plane of the substrate to be separated (102; 202).

6. Apparatus according to claim 1, characterized in that the gripper (108; 208) has openings, through which fluid can be suctioned or emitted.

7. Apparatus according to claim 1, characterized in that the gripper (108; 208), in a top view, is formed bar shaped, finger shaped, o-shaped, u-shaped, v-shaped, or has a flat shape.

8. Apparatus according to claim 1, characterized in that the carrying device (104; 204) has means through which the substrates to be separated (102; 202) can be oriented along a tilt angle α.

9. Apparatus according to claim 8, characterized in that the tilt angle α is chosen in such a manner that the angle between the feed direction (105; 205) and that surface normal of the substrate surface of the individual substrates (102; 202) that points more in the feed direction is positive, being equivalent with a backward inclination of the substrates.

10. Apparatus according to claim 1, characterized in that the carrying device (104; 204) is movable in at least one direction.

11. Apparatus according to claim 10, characterized in that the carrying device (104; 204) and/or the substrate stack (103; 203) is/are movable against the pressing element (122; 222).

12. Apparatus according to claim 10, characterized in that the carrying device (204) and/or the substrate stack (203) is/are movable against the position detection element (220).

13. Apparatus according to claim 1, characterized in that it further comprises a transporting device (113; 213) that is arranged above the substrate stack (103; 203) with the substrates to be separated (102; 202).

14. Apparatus according to claim 3, characterized in that the position detection device (220) comprises a sensor (222) for checking of contact of a substrate (202).

15. Apparatus according to claim 2, characterized in that the pressing element (122; 222) is arranged in such a manner that the gripper (108; 208) can be positioned between its pressing pins (123; 223).

16. Method for the fanning, separation and transportation of disc shaped substrates using an apparatus, substantially comprising the following assembly groups:
a carrying device arranged within a fluid (104; 204), in which the individual substrates (102; 202), in feed direction (105; 205), are sequentially arranged standing one after another in the form of a substrate stack (103; 203),
an unloading device (107; 207) for the separation and transportation of at least one substrate (102; 202), wherein the unloading device (107; 207) comprises a gripper (108; 208) with means by the aid of which the substrate (102; 202) can be taken up and guided away from the carrying device (104; 204),
a flow device (117; 217) for fanning of at least a part of the substrate stack (103; 203), and
a pressing element (122; 222) that acts against the fanned substrates (102; 202)
, wherein the method comprises the following steps:
a. moving of the carrying device (104; 204) together with the substrate stack (103; 203), or of the substrate stack (103; 203), respectively, in feed direction (105; 205) against the pressing element (123; 223) to achieve an unloading position for the substrate to be separated (102; 202),
b. fanning of at least a region of the substrate stack (103; 203) by a flow device (117; 217) in such a manner that interspaces (119; 219) develop;
c. separating of the substrate by
positioning of the gripper (108; 208) almost parallel to the planar design of the substrate (102; 202),
establishing of an adhesive contact between substrate (102; 202) and gripper (108; 208), and
removing of the substrate (102; 202) within the fluid perpendicular to the feed direction (105, 205), or parallel to the planar design of the substrates (102; 202), respectively.

17. Method according to claim 16, characterized in that interspaces (119; 219) are developed within the substrate stack (103; 203) due to the fanning by the flow device (117; 217), and that fluid cushions develop in the interspaces (119; 219) due to the fluid stream of the flow device (117; 217), exerting a damping effect on the substrate to be separated (102; 202) upon contacting of the gripper (108; 208).
